(19) United States
(12) Patent Application Publication
(10) Pub. No.: US 2015/0168324 A1
(43) Pub. Date: Jun. 18, 2015

(54) METHOD FOR DETERMINING THERMAL CONDUCTIVITY AND THERMAL DIFFUSIVITY OF MATERIALS

(71) Applicant: SCHLUMBERGER TECHNOLOGY CORPORATION, Sugar Land, TX (US)

(72) Inventors: Evgeny Yurievich Popov, Oktyabrya (RU); Anton Vladimirovich Parshin, Bashkortostan (RU); Yury Anatolievich Popov, Moscow (RU)

(21) Appl. No.: 14/573,780

(22) Filed: Dec. 17, 2014

(30) Foreign Application Priority Data
Dec. 18, 2013 (RU) 2013156001

(51) Int. Cl. G01N 25/18

(52) U.S. Cl. CPC G01N 25/18

(57) ABSTRACT

Electrical signals corresponding to initial temperatures of surfaces of a sample under study and of at least two reference samples with known thermal conductivity and thermal diffusivity are registered. The surfaces of the samples under study and of the reference samples are heated by an optical heating source and electrical signals corresponding to temperatures of the heated surfaces of the samples under study and of the reference samples along a heating line and also along a line parallel to the heating line and spaced by a distance therefrom are registered. The thermal conductivity and the thermal diffusivity of the sample under study are determined on the basis of a difference between output electrical signals corresponding to the heated and unheated surfaces of the samples under study and the reference samples.

### CROSS-REFERENCE TO RELATED APPLICATION

This application claims priority to Russian Application No. 2013156001 filed Dec. 18, 2013, which is incorporated herein by reference in its entirety.

### BACKGROUND

The invention relates to methods for determining thermal conductivity, thermal diffusivity and volumetric heat capacity of materials, and can be used to analyze thermal conductivity, thermal diffusivity, volumetric heat capacity, texture, structure, porosity of geomaterials, construction and other natural and industrial materials in different fields of science and enginery.

Known is a method for contactless determining thermal conductivity and thermal diffusivity of materials (Popov, Y. A., Spasennykh, M. Y., Miklashevskiy, D. E., Parshin, A. V., Stenin, V. P., Chertenkov, M. V., Novikov, S. V., Tarelko, N. F., et al. 2010. Thermal Properties of Formations from Core Analysis: Evolution in Measurement Methods, Equipment, and Experimental Data in Relation to Thermal EOR. CSUG/SPE 137639, Canadian Unconventional Resources & International Petroleum Conference, Calgary, Alberta, Canada, 19-21 October). The measurement process in this method comprises sequential heating of samples of materials and of two reference samples with known thermal conductivity and thermal diffusivity; and registering electrical signals of temperature sensors, which correspond to temperatures of heated surfaces of material samples and of two reference samples in different portions of their surface. The heating is carried out by a moving heating spot generated by an optical heating source, while optical sensors registering an infrared radiation of the surfaces of the material sample and of the reference samples are used to register electrical signals fixing a heating temperature level of the surface of the samples in various portions thereof. The thermal conductivity and the thermal diffusivity of the material sample are determined based on results of registering differences of electrical signals which correspond to excessive temperatures of the heated surfaces of the material samples and of the reference samples with the known thermal conductivity and thermal diffusivity, and on the basis of known values of the thermal conductivity and the thermal diffusivity. To provide the same effective power in the heating spot for all samples and the same dependency of electrical signals of the infrared temperature sensors upon a radiation coefficient of the sample surfaces, working surfaces of all material samples and of the reference samples with the known thermal conductivity and thermal diffusivity are treated before measurement so as to provide equal absorption coefficients and equal radiation coefficients of the heated surfaces of the material sample and of the samples with the known thermal conductivity and thermal diffusivity. To this end, for example, the heated surfaces of the sample and of the reference samples are coated with a layer of the same substance, for example, a paint or an adhesive tape.

The disadvantage of the prior art method for contactless determining a thermal conductivity and a thermal diffusivity of materials is the need to apply a special coating—a paint, an adhesive tape etc.—onto heated surfaces of the sample of the material under study and of two samples with known values of the thermal conductivity and the thermal diffusivity. Negative subsequences of applying the coating onto the surface of the samples of the materials are loss of time for applying the coating and for removal of the coating after completing measurements; penetration of the coating, if the paint is used, into pores and cracks in the samples of the materials under examination which can essentially change properties of the materials; inadmissible impairment of the surface of the materials if the complete removal of the paint is impossible or the surface of the materials is damaged during the paint removal, and gapping between the applied film of the coating in case of a harsh surface of samples of the materials, which result in substantial distortion of results of thermal conductivity and thermal diffusivity measurements.

### SUMMARY

The disclosed method for determining a thermal conductivity and a thermal diffusivity of materials provides for increased accuracy of determining the thermal conductivity and the thermal diffusivity of materials without any preliminary treatment of the surface of materials to equalize the optical characteristics thereof.

The method comprises registering, by a first optical temperature sensor, electrical signals which correspond to an initial temperature of a surface of at least one material sample under study and an initial temperature of surfaces of at least two reference samples with known thermal conductivity and thermal diffusivity. The surfaces of the samples under study and of the reference samples are heated by an optical heating source which moves at a constant speed, and electrical signals which correspond to temperatures of the heated surfaces of the samples under study and of the reference samples are registered by a second optical temperature sensor which moves along a heating line relative to the samples under study and the reference samples at the same speed as the optical heating source. Electrical signals which correspond to temperatures of the heated surfaces of the samples under study and of the reference samples along a line parallel to the heating line and at a distance from the heating line are registered by a third optical temperature sensor which moves relative to the samples under study and to the reference samples at the same speed as the optical heating source. A thermal conductivity of each j^{th} sample under study is determined according to the formula:

$${λ}_{j} = \frac{{\sum }_{i = 1}^{i = N} {λ}_{Ri} \cdot Δ {U}_{1 R i} \cdot \frac{{ɛ}_{sj} {ρ}_{sj}}{{ɛ}_{R i} {ρ}_{R i}}}{N \cdot Δ {U}_{1 j}} ,$$

where λⱼ is a thermal conductivity of the j^{th} sample under study, 1≦j≦N₀;
N₀ is a number of the samples under study;
N is a number of the reference samples;
λ_{Ri} is a thermal conductivity of an i^{th} reference sample, 1≦i≦N;
ΔU_{1Ri} is a difference between output electrical signals of the first and the second temperature sensors registering an initial temperature of the i^{th} reference sample and a temperature of the i^{th} reference sample on the heating line after heating;
ΔU₁ⱼ is a difference between output electrical signals of the first and the second temperature sensors registering an initial temperature of the j^{th} sample under study and a temperature of the j^{th} sample under study on the heating line after the heating;
ε_{Sj} is a radiation coefficient of the j^{th} sample under study;
ρ_{Sj} is an absorption coefficient of the j^{th} sample under study;
ρ_{Ri} is a radiation coefficient of the i^{th} reference sample;
ρ_{R1} is an absorption coefficient of the i^{th} reference sample.

A thermal diffusivity aⱼ of each j^{th} sample under study is determined according to the formula:

$${a}_{j} = \frac{1}{N} \cdot {\sum }_{m , k = 1}^{m , k = N} \frac{{a}_{Rm} \cdot ln ( \frac{{λ}_{Rm} \cdot Δ {U}_{2 Rm}}{{λ}_{Rk} \cdot Δ {U}_{2 Rk}} \cdot \frac{{ɛ}_{Rk} {ρ}_{Rk}}{{ɛ}_{Rm} {ρ}_{Rm}} )}{\begin{matrix}ln ( \frac{{λ}_{Rm} \cdot Δ {U}_{2 Rm}}{{λ}_{Rk} \cdot Δ {U}_{2 Rk}} \cdot \frac{{ɛ}_{Rk} {ρ}_{Rk}}{{ɛ}_{Rm} {ρ}_{Rm}} ) + \\ \frac{{a}_{Rk} - {a}_{Rm}}{{a}_{Rk}} \cdot ln ( \frac{( {λ}_{Rm} \cdot Δ {U}_{1 Rm} + {λ}_{Rk} \cdot Δ {U}_{1 Rk} ) \cdot Δ {U}_{2 j}}{{λ}_{Rm} \cdot Δ {U}_{1 j} \cdot Δ {U}_{2 Rm} \cdot ( 1 + \frac{{ɛ}_{Rm} {ρ}_{Rm}}{{ɛ}_{Rk} {ρ}_{Rk}} )} )\end{matrix}}$$

where
N is the number of the reference samples;
a_{Rm} and a_{Rk} are thermal diffusivities of an m^{th} reference sample and a k^{th} reference sample, respectively (1≦m≦N, 1≦k≦N), m and k are elements of combinations of N elements by 2, n is a total number of the combinations of N elements by 2;
ΔU_{2Rm} and ΔU_{2Rk} are differences between output electrical signals of the first and the third temperature sensors registering an initial temperature of m^{th} and k^{th} reference samples, respectively, and a temperature of m^{th} and k^{h} reference samples, respectively, at the distance from the heating line after the heating;
ΔU₂ⱼ is a difference between output electrical signals of the first and the third temperature sensors registering an initial temperature of the j^{th} sample under study and a temperature of the j^{th} sample under study at the distance from the heating line after the heating.

In accordance with one of embodiments of the disclosure, a ratio of products of the absorption coefficient by the radiation coefficient for the reference samples with the known thermal conductivity and thermal diffusivity is determined as:

$$\frac{{ɛ}_{Rk} {ρ}_{Rk}}{{ɛ}_{Rm} {ρ}_{Rm}} = \frac{Δ {U}_{1 R k} \cdot {λ}_{Rk}}{Δ {U}_{1 R m} \cdot {λ}_{R m}}$$

The surfaces of the reference samples with the known thermal conductivity and thermal diffusivity can be treated preliminary so as to provide the equality:

ε_{Ri}ρ_{Ri}=ε_{R}ρ_{R},

wherein the thermal conductivity of each sample under study is determined as:

$${λ}_{j} = \frac{{\sum }_{i = 1}^{N} {λ}_{R i} \cdot Δ {U}_{1 Ri}}{N \cdot Δ {U}_{1 j}} \cdot \frac{{ɛ}_{sj} {ρ}_{sj}}{{ɛ}_{R} {ρ}_{R}} ,$$

and the thermal diffusivity of each sample under study is determined from the relationship:

$${a}_{j} = \frac{1}{n} {\sum }_{m , k = 1}^{m , k = N} \frac{{a}_{Rm} \cdot ln ( \frac{{λ}_{Rm} \cdot Δ {U}_{2 Rm}}{{λ}_{Rk} \cdot Δ {U}_{2 Rk}} )}{ln ( \frac{{λ}_{Rm} \cdot Δ {U}_{2 Rm}}{{λ}_{Rk} \cdot Δ {U}_{2 Rk}} ) + \frac{{a}_{Rk} - {a}_{Rm}}{{a}_{Rk}} \cdot ln ( \frac{{λ}_{j} \cdot Δ {U}_{2 j}}{{λ}_{Rm} \cdot Δ {U}_{2 Rk}} )}$$

The preliminary treatment of the surfaces of the reference samples with the known thermal conductivity and thermal diffusivity may consists in applying a thin layer of a homogeneous substance or in coating with a thin adhesive film.

If two of more samples under study are used, the samples under study are preliminary divided into groups each including the samples under study with identical optical characteristics. One sample is selected from each group and the thermal conductivity is determined for each selected sample under study. Then a whole surface of each selected sample under study or a part of said surface is treated along the heating line so as to provide the same product of the absorption coefficient by the radiation coefficient of the treated surfaces of the selected samples under study and the reference samples. Afterwards, the thermal conductivity in the treated portions of the selected material samples under study is determined and, based on results of two measurements of the thermal conductivity for the treated surface portions of the selected samples under study, for each selected sample under study a ratio (εₛρₛ)/(ε_{R}ρ_{R}) of the product of the absorption coefficient by the radiation coefficient of each selected sample under study to the product of the absorption coefficient by the radiation coefficient of the reference samples with the known thermal conductivity and thermal diffusivity is determined.

In accordance with one of embodiments of the method, when determining the thermal conductivity in the treated portions of the surfaces of the selected material samples under study, thermal conductivity in untreated portions of the surfaces for each selected sample under study is determined and differences between output signals from the first and the second temperature sensors registering temperature in the untreated portions of each selected sample under study before and after the treatment of the surfaces are compared. A variation of a heating power for each sample in measurement after the treatment of the surface with respect to the measurement before the treatment of the surface is determined, and the determined heating power variation is taken into account in determining the ratio of the product of the absorption coefficient by the radiation coefficient of the selected samples under study to the product of the absorption coefficient by the radiation coefficient of the reference samples with the known thermal conductivity and thermal diffusivity.

### BRIEF DESCRIPTION OF DRAWINGS

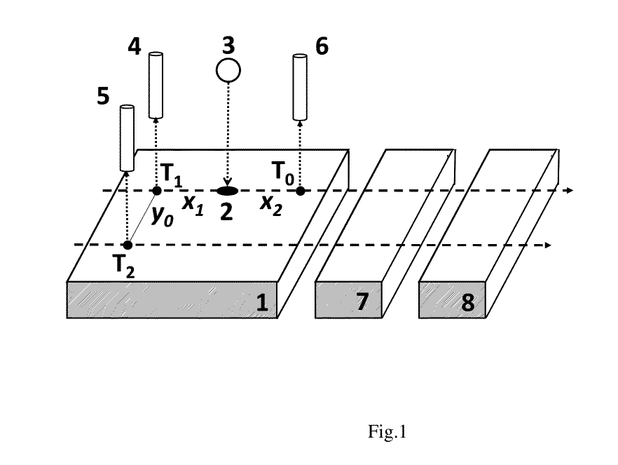

The invention is explained by the drawing where FIG. 1 illustrates a scheme for carrying out the disclosed method.

### DETAILED DESCRIPTION

To determine a thermal conductivity and a thermal diffusivity of a material sample 1, a surface of the sample is heated by a moving heating spot 2, generated by an optical heating source 3—a laser or a special electrical lamp with a concentrated heating spot—at a constant useful heating power of the source. During the heating, an electrical signal corresponding to a heating temperature T₁ of the surface is registered by a sensor 4. The heating spot 2 is located at a distance x₁ from an area where the electrical signal corresponding to the temperature T₁ of the surface of the sample 1 is registered by the temperature sensor 4. Another temperature sensor 5 is located at a distance x₁ from the heating spot 2 along a heating line and at a distance yₒ from the heating line. An electrical signal corresponding to a heating temperature T₂ on the surface of the sample 1 along a line parallel to a line of movement of the heating spot 2 and spaced from the line of movement of the heating spot 2 by a distance yₒ is registered, by the temperature sensor 5. A sensor 6 is located on the line of movement of the heating spot 2 in front of the heating spot 2 at a distance X₂, said sensor registering based on the infrared radiation of the surface an electrical signal corresponding to an initial temperature T₀ of the surface of the sample 1 along the heating line.

In the process of measurement of the thermal conductivity and the thermal diffusivity of the sample 1, a constant-speed movement of the heating spot 2 along the surface of the sample 1 is provided for heating the sample surface areas for which the electrical signals are registered corresponding to the temperatures T₁, T₂ and T₀. For conducting measurements on several samples of materials instead of a single material sample 1, several samples of materials may be arranged. When conducting measurements, two additional different reference samples 7 and 8 of solid-state bodies with known values of thermal conductivity and thermal diffusivity are installed in one line with one or several samples of the materials under study. In the process of measurements, two reference samples 7 and 8 with known values of the thermal conductivity and the thermal diffusivity are sequentially heated and electrical signals corresponding to temperatures of the heated surfaces of two reference samples 7 and 8 are registered before and after the heating of the reference samples along both the heating line and a line parallel to the heating line and spaced therefrom.

Differences between output electrical signals from the temperature sensors 4 and 6 and differences between electrical signals from the temperature sensors 5 and 6, corresponding to excessive heating temperatures of the samples under study and the reference samples 7 and 8 along the heating line and along the line spaced by a distance therefrom. An excessive heating temperature for the heating line is a difference between temperatures of the surfaces of the samples under study and the reference samples on the heating line after the heating and temperatures of the surfaces of the samples under study and the reference samples before the heating. An excessive heating temperature for the line parallel to the heating line and shifted relative thereto is a difference between temperatures of the surfaces of the samples under study and the reference samples on the line parallel to the heating line after the heating and temperatures of the surfaces of the samples under study and the reference samples prior to the heating.

The thermal conductivity and the thermal diffusivity of the sample 1 are determined based on results of determining the differences between electrical signals which correspond to the excessive temperatures of the heated surfaces of the material samples and the reference samples with the known thermal conductivity and thermal diffusivity, and based on the known values of the thermal conductivity and the thermal diffusivity for two reference samples. The thermal conductivity of the material sample 1 and other samples under study is determined by the relationship:

$$λ = \frac{{λ}_{R 1} \cdot Δ {U}_{1 R 1} + {λ}_{R 2} \cdot Δ {U}_{1 R 2}}{2 Δ {U}_{1}} , \qquad ( 1 )$$

where λ is the thermal conductivity of the sample under study and other material samples under study;
λ_{R1} and λ_{R2}—the thermal conductivity of the reference samples 7 and 8 with the known thermal conductivity and thermal diffusivity, respectively;
ΔU₁ is the difference between the electrical signals corresponding to the difference of the temperatures T₁ and T₀ on the surface of the sample 1 and on the surface of other samples of the materials under study, said signals having been registered by the temperature sensors 4 and 6, respectively;
ΔU_{1R1} and ΔU_{1R2} are the differences between the electrical signals for the reference samples 7 and 8 with the known thermal conductivity and thermal diffusivity, wherein ΔU_{1R1} corresponds to the difference of the temperatures T_{1R1} and T_{1R0} registered by the temperature sensors 4 and 6, respectively, on the surface of the reference sample 7, while ΔU_{1R1} corresponds to the difference of the temperatures T_{2R1} and T_{2R0} registered by the temperature sensors 4 and 6, respectively, on the surface of the reference sample 8.

Thermal diffusivity of the sample 1 under study and other samples under study is determined by the relationship:

$$a = \frac{{a}_{R 1} \cdot ln ( \frac{{λ}_{R 1} \cdot Δ {U}_{2 R 1}}{{λ}_{R 2} \cdot Δ {U}_{2 R 2}} )}{ln ( \frac{{λ}_{R 1} \cdot Δ {U}_{2 R 1}}{{λ}_{R 2} \cdot Δ {U}_{2 R 2}} ) + \frac{{a}_{R 2} - {a}_{R 1}}{{a}_{R 2}} \cdot ln ( \frac{λ \cdot Δ {U}_{2}}{{λ}_{R 1} \cdot Δ {U}_{2 R 1}} )} , \qquad ( 2 )$$

where a is the thermal diffusivity of the sample 1 under study and other material samples under study;
a_{R1} and a_{R2}—the thermal diffusivity of the reference samples 7 and 8 with the known thermal conductivity and thermal diffusivity, respectively;
ΔU₂ is the difference between the electrical signals corresponding to the difference of the temperatures T₂ and T₀ on the surface of the sample 1 and on the surface of other samples under study, said signals having been registered by the temperature sensors 5 and 6, respectively;
ΔU_{2R1} and ΔU_{2R2} are the differences between the electrical signals for the reference samples 7 and 8 with the known thermal conductivity and thermal diffusivity, said signals having been registered by the temperature sensors 5 and 6, respectively, wherein ΔU_{2R1} corresponds to the difference of the temperatures T_{2R1} and T_{1R0} registered by the temperature sensors 5 and 6, respectively, on the surface of the reference sample 7, while ΔU_{2R1} corresponds to the difference of the temperatures T_{2R1} and T_{2R0} registered by the temperature sensors 5 and 6, respectively, on the surface of the reference sample 8.

It is known (Popov Yu., Berezin V., Semenov V., Korostelev V. Complex detailed investigations of the thermal properties of rocks on the basis of a moving point source. Izvestiya, Earth Physics, Vol. 21, No. 1, 1985, pp. 64-70) that, when a sample of a solid-state body is heated by a moving heating spot and when excessive heating temperatures are registered by moving temperature sensors, an excessive heating temperature ΔT₁ of the sample of the solid-state body in an area where the temperature sensor 4 registers said temperature is theoretically determined by the relationship:

ΔT₁=q/(2πλx₁), (3)

where q—is a local heating source power in the heating spot,
while an excessive heating temperature ΔT₂ of the sample of the solid-state body in an area where the temperature sensor 5 registers said temperature is theoretically determined by the relationship:

$$Δ {T}_{2} = \frac{q}{2 π λ L} \cdot exp ( \frac{v ( {x}_{1} - L )}{2 a} ) , \qquad ( 4 )$$

where L=((x₁)²+(y₀)²)^{1/2}, v is a speed of movement of the heating spot and the area where the temperature sensor 5 registeres the temperature, said movement taking place relative to the heated material sample.

When the optical source heats the surface of the material sample 1 and a radiation of a power q, i.e. the power absorbed by the sample, enters the surface of the sample, a heating power is ρq, where ρ is a coefficient of absorbing the radiation by the surface of the sample. Therefore, a true excessive heating temperature (ΔT₁)ₚ of the sample surface in the area where the temperature sensor 4 registers said temperature will be:

(ΔT₁)ₚ=ρq/(2πλx₁), (5)

while a true excessive heating temperature (ΔT₂)ₚ of the sample surface in the area where the temperature sensor 5 registers said temperature will be:

$${( Δ {T}_{2} )}_{p} = \frac{ρ q}{2 π λ L} \cdot exp ( \frac{v ( {x}_{1} - L )}{2 a} ) \qquad ( 6 )$$

The difference between an electrical signal U₆ of the infrared radiometer 6 for an unheated surface of the samples with the temperature T₀ and an electrical signal U₄ of the infrared radiometer 4 or an electrical signal U₆ of the infrared radiometer for the heated surface of the samples with a temperature T (where T is T₁ for the radiometer 4 and is T₂ for the radiometer 5) can be presented as:

ΔU≅μr−μr₀=μ(r−r₀)=Δr, (7)

where μ is a conversion coefficient of the infrared radiometer, which should be the same, so one-type infrared radiometers 4, 5 and 6 should be used; r is a radiant emittance of the heated surface of the sample or of the reference sample; r₀ a radiant emittance of the unheated surface of the sample under study or of the reference sample, Δr=r−r₀.

According to the Stefan-Boltzman law, the radiant emittance can be expressed in terms of a surface temperature for a sample of a material under study or a reference sample as:

r=εσT⁴, (8)

where ε is a radiation coefficient of the heated surface of the sample; σ is the Stefan-Boltzman constant, T is an absolute surface temperature of the sample of the material under study or the reference sample.

According to (7) and (8), the difference AU of electrical signals can be presented as follows:

ΔU≅μ(r−r₀)=μεσ(T⁴−T₀⁴). (9)

Since all studied and reference samples are under normal environmental conditions, then, the distinction in their original temperatures T₀ can be considered as ignorable in comparison with the absolute temperature T (290-310 K) of the samples. Values of excessive heating temperatures ΔT of the samples in an area where the temperature sensors 4, 5 and 6 register said temperatures usually are not higher than values of 5-8 K, i.e. also are values much less that the absolute temperatures of the samples.

It is known that an increment ΔF for any function F=F(z) at small variations Δz of an argument can be expressed as:

$$Δ F = \frac{d F}{d z} \cdot Δ z , \qquad ( 10 )$$

where

$$\frac{d F}{d z}$$

is the first z-derivative of the function F.

Thus, if levels of the excessive temperatures ΔTᵢ are essentially less that the absolute temperature T of the sample surfaces, which is similar for all heated samples, any difference ΔU of signals, i.e. the differences ΔU₁, ΔU_{1R1} and ΔU_{1R2} of electrical signals from the infrared temperature sensors 4 and 6, which correspond to the excessive temperature (ΔT₁)ₚ of the heated sample and to the excessive temperatures (ΔT_{1R1})ₚ and (ΔT_{1R2})ₚ of the reference samples, as well as the differences ΔU₂, ΔU_{2R1} and ΔU_{2R2} of electrical signals from the infrared temperature sensors 5 and 6, which correspond to the excessive temperature (ΔT₂)ₚ of the heated sample and to the excessive temperatures (ΔT_{2R1})ₚ and (ΔT_{2R2})ₚ of the reference samples, can be presented on the basis of the Stefan-Boltzman law as follows:

ΔU≅μ·Δr≅μ·4εσT³(ΔT)ₚ≅μ·4ερσT³ΔT, (11)

where μ is a conversion coefficient of the infrared radiometer; r is a radiant emittance of the sample surface; Δr is an improvement in the radiant emittance of the material sample after the heating thereof; ρ is an absorption coefficient of the heated surface of the sample; e is a radiation coefficient of the heated surface of the sample; T is an absolute temperature of the heated surface of the sample; ΔT is a excessive temperature ΔT₁ or ΔT₂ of the heated surface of the sample.

When using the infrared radiometers 4, 5 and 6 having different coefficients of conversion of a recorded radiant emittance into an electrical signal, it is possible to write the formula (11) as follows:

ΔU=KερΔT, (12)

where K=4μσT³.

If there is no special coating on the samples under study and the reference samples with the known thermal conductivity and thermal diffusivity before the measurements, a thermal conductivity of each j^{th} material sample of N₀ samples of the materials under study which are tested in one scanning process (1≦j≦N₀) can be determined from the formula following from the formulae (1) and (12):

$${λ}_{j} = \frac{{λ}_{R 1} \cdot Δ {U}_{1 R 1} \cdot \frac{{ɛ}_{s} {ρ}_{s}}{{ɛ}_{R 1} {ρ}_{R 1}} + {λ}_{R 2} \cdot Δ {U}_{1 R 2} \cdot \frac{{ɛ}_{s} {ρ}_{s}}{{ɛ}_{R 2} {ρ}_{R 2}}}{2 Δ {U}_{1 j}} , \qquad ( 13 )$$

where ΔU₁ⱼ is a difference between the electrical signals from the sensors 4 and 6 for the j^{th} sample under study,
while a thermal diffusivity for each j^{th} material sample of N₀ samples of the materials under study can be determined from the formula following from the formulae (2) and (12):

$${a}_{j} = \frac{{a}_{R 1} \cdot ln ( \frac{{λ}_{R 1} \cdot Δ {U}_{2 R 1}}{{λ}_{R 2} \cdot Δ {U}_{2 R 2}} \cdot \frac{{ɛ}_{R 2} {ρ}_{R 2}}{{ɛ}_{R 1} {ρ}_{R 1}} )}{\begin{matrix}ln ( \frac{{λ}_{R 1} \cdot Δ {U}_{2 R 1}}{{λ}_{R 2} \cdot Δ {U}_{2 R 2}} \cdot \frac{{ɛ}_{R 2} {ρ}_{R 2}}{{ɛ}_{R 1} {ρ}_{R 1}} ) + \frac{{a}_{R 2} - {a}_{R 1}}{{a}_{R 2}} \cdot \\ ln ( \frac{( {λ}_{R 1} \cdot Δ {U}_{1 R 1} + {λ}_{R 2} \cdot Δ {U}_{1 R 2} ) \cdot Δ {U}_{2 j}}{{λ}_{R 1} \cdot Δ {U}_{1 j} \cdot Δ {U}_{2 R 1} \cdot ( 1 + \frac{{ɛ}_{R 1} {ρ}_{R 1}}{{ɛ}_{R 2} {ρ}_{R 2}} )} )\end{matrix}} , \qquad ( 14 )$$

where ΔU₂ⱼ is a difference between the electrical signals from the sensors 5 and 6 for the j^{th} sample under study; an index “s” at the absorption and the radiation coefficients corresponds to characteristics of the samples under study; and indices R₁ and R₂ at the absorption and the radiation coefficients correspond to the samples 7 and 8 with the known thermal conductivity and thermal diffusivity.

When using N (N≧2) reference samples with known thermal conductivity and thermal diffusivity, placed in series with the samples under study and used to determine thermal conductivity and thermal diffusivity of the samples under study, the formula (9) takes the form:

$${λ}_{j} = \frac{{\sum }_{i = 1}^{i = N} {λ}_{Ri} \cdot Δ {U}_{1 R i} \cdot \frac{{ɛ}_{Sj} {ρ}_{Sj}}{{ɛ}_{Ri} {ρ}_{Ri}}}{N \cdot Δ {U}_{1 j}} , \qquad ( 15 )$$

and the formula (14) takes the form:

$${a}_{j} = \frac{1}{n} \cdot {\sum }_{m , k = 1}^{m , k = N} \frac{{a}_{Rm} \cdot ln ( \frac{{λ}_{Rm} \cdot Δ {U}_{2 R m}}{{λ}_{Rk} \cdot Δ {U}_{2 R k}} \cdot \frac{{ɛ}_{Rk} {ρ}_{Rk}}{{ɛ}_{Rm} {ρ}_{Rm}} )}{\begin{matrix}ln ( \frac{{λ}_{Rm} \cdot Δ {U}_{2 R m}}{{λ}_{Rk} \cdot Δ {U}_{2 R k}} \cdot \frac{{ɛ}_{Rk} {ρ}_{Rk}}{{ɛ}_{Rm} {ρ}_{Rm}} ) + \frac{{a}_{Rk} - {a}_{Rm}}{{a}_{Rk}} \cdot \\ ln ( \frac{( {λ}_{Rm} \cdot Δ {U}_{1 R m} + {λ}_{Rk} \cdot Δ {U}_{1 R k} ) \cdot Δ {U}_{2 j}}{{λ}_{Rm} \cdot Δ {U}_{1 j} \cdot Δ {U}_{2 R m} \cdot ( 1 + \frac{{ɛ}_{Rm} {ρ}_{Rm}}{{ɛ}_{Rk} {ρ}_{Rk}} )} )\end{matrix}} \qquad ( 16 )$$

It is proposed to carry out the direct determination of the ratio (ε_{RK}ρ_{Rk})/(ε_{Rm}ρ_{Rm}) included in the formula (16) and necessary to determine the thermal diffusivity of the samples by heating the samples with the known thermal conductivity and thermal diffusivity and registering electrical signals ΔU_{1Rk} and ΔU_{1Rm} by the sensors 4 and 6. It follows from the formulae (3) and (12) that

$$\frac{Δ {U}_{1 R 1}}{Δ {U}_{1 R 2}} = \frac{( {ɛ}_{R 1} {ρ}_{R 1} ) \cdot {λ}_{R 2}}{( {ɛ}_{R 2} {ρ}_{R 2} ) \cdot {λ}_{R 1}} , \qquad ( 17 )$$

from which we obtain a relationship for evaluation of the ratio (ε_{Rk}ρ_{Rk})/(ε_{Rm}ρ_{Rm}) by determining the electrical signals ΔU_{1Rk} and ΔU_{1Rm}, and based on the known values λ_{Rk} and λ_{Rm} of the thermal conductivity for the reference samples:

$$\frac{{ɛ}_{Rk} {ρ}_{Rk}}{{ɛ}_{Rm} {ρ}_{Rm}} = \frac{Δ {U}_{1 R k} \cdot {λ}_{Rk}}{Δ {U}_{1 Rm} \cdot {λ}_{Rm}} . \qquad ( 18 )$$

It is technically simple to preliminary treat the surfaces of each i^{th} reference sample of N reference samples with the known thermal conductivity and thermal diffusivity so as to provide the same product for all samples, i.e. to provide the equality:

ε_{Ri}ρ_{Ri}=ε_{R}ρ_{R}, (19)

In such a case, thermal conductivity of each j^{th} studied sample after completion of heating the samples under study and the reference samples with the known thermal conductivity and thermal diffusivity can be determined according to the relationship following from the relationship (15) with the proviso for compliance with the condition (19):

$${λ}_{j} = \frac{{\sum }_{i = 1}^{N} {λ}_{Ri} \cdot Δ {U}_{1 R i}}{N \cdot Δ {U}_{1 j}} \cdot \frac{{ɛ}_{Sj} {ρ}_{Sj}}{{ɛ}_{R} {ρ}_{R}} , \qquad ( 20 )$$

while a thermal diffusivity of each j^{th} material sample under study can be determined from the relationship following from the relationship (16) with the proviso for compliance with the condition (19):

$${a}_{j} = \frac{1}{n} {\sum }_{m , k = 1}^{m , k = N} \frac{{a}_{Rm} \cdot ln ( \frac{{λ}_{Rm} \cdot Δ {U}_{2 R m}}{{λ}_{Rk} \cdot Δ {U}_{2 R k}} )}{ln ( \frac{{λ}_{Rm} \cdot Δ {U}_{2 R m}}{{λ}_{Rk} \cdot Δ {U}_{2 R k}} ) + \frac{{a}_{Rk} - {a}_{Rm}}{{a}_{Rk}} \cdot ln ( \frac{{λ}_{j} \cdot Δ {U}_{2 j}}{{λ}_{Rm} \cdot Δ {U}_{2 R k}} )} . \qquad ( 21 )$$

In order to provide compliance with the condition ε_{Ri}ρ_{Ri}=ε_{R}ρ_{R}, it is proposed to carry out a preliminary treatment of the reference sample surfaces by applying a thin layer of a uniform substance, which will lead to the equality of the absorption coefficients and to the equality of the radiation coefficients for all reference samples. It is possible to carry out such a treatment by coating the surface of each reference sample with a thin layer of the same paint, wherein said layer should be opaque for the radiation of the optical heat source and for the radiation of the heated sample surfaces.

As another method for preliminary treating the surfaces of the reference samples with the known thermal conductivity and thermal diffusivity in order to provide compliance with the condition ε_{Ri}ρ_{Ri}=ε_{R}ρ_{R}, it is proposed to apply a thin adhesive film onto said surfaces, wherein said film will be opaque for the radiation of the optical heating source and for the radiation from the heated surfaces of samples of the thin layer of the uniform substance.

In every one of these cases when the surfaces of the reference samples with the known thermal conductivity and thermal diffusivity are coated in order to provide said surfaces with equal absorption coefficients and equal radiation coefficients, the thermal conductivity for each sample under study after completion of heating the samples under study and the reference samples can be determined according to the relationship (20) following from the relationship (15) with the proviso for compliance with the condition (19), while the thermal diffusivity for each sample under study can be determined according to the relationship (21) following from the relationship (16) with the proviso for the proviso for compliance with the condition (19).

If the thermal conductivity and the thermal diffusivity are measured for two or more material samples under study, when the surfaces of the reference samples with the known thermal conductivity and thermal diffusivity were coated with the thin layer of the substance in order to provide compliance with the condition ε_{Ri}ρ_{Ri}=ε_{R}ρ_{R}, it is proposed to preliminary divide the samples under study into groups each including the samples under study with equal absorption coefficients and equal radiation coefficients or equal products ε_{S}ρ_{S}. Next, it is proposed to select one sample from each group. A thermal conductivity should be determined using the formula (15) for each selected sample of the material under study. A value of the thermal conductivity measured in such a manner will be distorted and will be a value λₑᵣᵣₒᵣ different from a true value due to indeterminacy of the absorption and radiation coefficients for the selected uncoated samples. If N reference samples are used and each sample is used to determine the thermal conductivity of the selected sample under study, the formula (15) takes the form:

$${λ}_{owuu 6} = \frac{{\sum }_{i = 1}^{N} {λ}_{R i} \cdot Δ {U}_{1 Ri}}{N \cdot Δ {U}_{1}} . \qquad ( 22 )$$

An error in measurement of the thermal conductivity for the selected uncoated sample is caused by the trueness of the formulae (15) and (22) only with the proviso that ε_{S}ρ_{S}=ε_{R}ρ_{R}, i.e. when the sample surfaces of the materials under study have the same product of the absorption and radiation coefficients as the reference samples with the known thermal conductivity and thermal diffusivity. But the ratio

$$\frac{{ɛ}_{S} {ρ}_{S}}{{ɛ}_{R} {ρ}_{R}}$$

is unknown in this case, as needed for the measurement error to take place. The measured value λₑᵣᵣₒᵣ is connected with the true value of the thermal conductivity for the selected sample by the relationship following from the relationships (15) and (22):

$$λ = {λ}_{owu 6} \cdot \frac{{ɛ}_{Sj} {ρ}_{Sj}}{{ɛ}_{R} {ρ}_{R}} . \qquad ( 23 )$$

After measurements of λₑᵣᵣₒᵣ, it is proposed to treat a surface of each selected sample under study or a part of said surface along the heating line so as to provide the same product of the absorption coefficient by the radiation coefficient for the treated surfaces of the selected samples under study and the reference samples with the known thermal conductivity and thermal diffusivity. This can be arranged, for example, by coating the surface of each selected sample or a part of said surface along the heating line with a layer of the same paint or the same adhesive tape as that used to coat the surface of the reference samples with the known thermal conductivity and thermal diffusivity. Thereafter, again by the formula (22) already correct for the present case now since compliance with the condition ε_{S}ρ_{S}=ε_{R}ρ_{R} is provided, the thermal conductivity is determined by heating the treated portions of the selected sample surfaces and registering excessive heating temperatures thereon. Next, on the basis of two thermal conductivity measurements for the selected samples under study—first, in the untreated surface portions and then in the treated surface portions—there is the step of determining, from the relationship (23), a ratio

$$\frac{{ɛ}_{S} {ρ}_{S}}{{ɛ}_{R} {ρ}_{R}}$$

of the product of the absorption coefficient by the radiation coefficient for each selected sample under study to the product of the absorption coefficient by the radiation coefficient for the reference samples with the known thermal conductivity and thermal diffusivity:

$$\frac{{ɛ}_{s} {ρ}_{s}}{{ɛ}_{R} {ρ}_{R}} = \frac{λ}{{λ}_{owu 6}} . \qquad ( 24 )$$

Next, the prior art method is used to measure the thermal conductivity and the thermal diffusivity of other samples from the same series as the selected sample, wherein a surface of each sample from said series is not coated with any coating. Since the relationship (24) is common for all samples of the present series and therefore the ratio

$$\frac{{ɛ}_{S} {ρ}_{S}}{{ɛ}_{R} {ρ}_{R}}$$

is known for all samples of the present series, the thermal conductivity of each studied sample of the present series is determined by the formula (20), while the thermal diffusivity of each studied sample from the present series is determined by the formula (21). In the same way, the prior art method is used to measure the thermal conductivity and the thermal diffusivity of all samples from other series, while the ratios

$$\frac{{ɛ}_{S} {ρ}_{S}}{{ɛ}_{R} {ρ}_{R}}$$

established preliminary for selected samples from each series are used for samples of each series, as shown above.

To improve the accuracy in determination of the ratio

$$\frac{{ɛ}_{S} {ρ}_{S}}{{ɛ}_{R} {ρ}_{R}}$$

for each selected sample from each series, the surface of each selected sample is divided into two parts along the heating line: a first part after the first measurements of the thermal conductivity (λₑᵣᵣₒᵣ)₁ thereon will be coated, prior to the second measurement of the thermal conductivity, with a layer of the same paint or the same adhesive tape as used to coat the surface of the reference samples with the known thermal conductivity and thermal diffusivity, in order to comply with the condition ε_{S}ρ_{S}=ε_{R}ρ_{R}, while the second part after the first measurements of the thermal conductivity (λₑᵣᵣₒᵣ₋₁)₂ thereon will be left without any treatment of the surface. After application of the coating onto the first part of the surface of each selected sample along the heating line, a true thermal conductivity λ in the first part of the selected sample is determined and additionally a thermal conductivity a (λₑᵣᵣₒᵣ₋₂)₂ in the untreated portions of the surfaces for each selected sample under study is determined. Upon that, a ratio (λₑᵣᵣₒᵣ₋₁)₂/(λₑᵣᵣₒᵣ₋₂)₂ of the thermal conductivity values a (λₑᵣᵣₒᵣ₋₁)₂ and (λₑᵣᵣₒᵣ₋₂)₂ obtained for the second part of the selected sample in measurements prior to and after the treatment of the first part of the surface is determined for each selected sample. According to the formula (15), the differences ΔU₁ of the output signals from the temperature sensors 4 and 6 recording a temperature in the untreated portions of each selected sample under study determine a measured value of the thermal conductivity of each sample. In case if a source power q is stable and identical in the heating of both the material samples under study and the reference samples with the known thermal conductivity and thermal diffusivity, a value of the heating source power has an influence upon the accuracy of measuring the thermal conductivity and the thermal diffusivity according to the formulae (3), (4), (12), (15) and (16). But if a random variation of power occurs between the first measurement of the thermal conductivity in the selected uncoated sample and the second measurement of the thermal conductivity in the selected coated sample of the first part, while the heating source power in both measurements of the thermal conductivity in the selected sample remains constant, then, according to the formulae (3), (12) and (22), this leads to an error in measurements of the thermal conductivity λ and therefore to an error in determination of a required ratio

$$\frac{{ɛ}_{S} {ρ}_{S}}{{ɛ}_{R} {ρ}_{R}} ,$$

as follows from the formula (24). According to the relationship (15), this error in determination of the ratio

$$\frac{{ɛ}_{S} {ρ}_{S}}{{ɛ}_{R} {ρ}_{R}}$$

will introduce an error to results of measuring the thermal conductivity in all other samples of the present series. To eliminate such the error in determination of the ratio

$$\frac{{ɛ}_{S} {ρ}_{S}}{{ɛ}_{R} {ρ}_{R}} ,$$

it is proposed to detect and eliminate such variations in the heating source power by comparing the excessive signal (ΔU₁)₁ during the first measurement of the thermal conductivity (λₑᵣᵣₒᵣ₋₂)₁ in that second part of the surface of the selected sample which will not be treated prior to the second measurement of the thermal conductivity after the coating of the second part of the surface of the selected sample, and the excessive signal (ΔU₁)₂ in the second measurement of the thermal conductivity in the same second part of the surface of the selected sample in which the result will be (λₑᵣᵣₒᵣ₋₂)₂. According to the formulae (3), (12) and (15), a relative variation

$$\frac{{( Δ {U}_{1} )}_{1}}{{( Δ {U}_{1} )}_{2}}$$

of the excessive signal can be determined from the relationship:

$$\frac{{( Δ {U}_{1} )}_{1}}{{( Δ {U}_{1} )}_{2}} = \frac{{( {λ}_{owu 6 - 2} )}_{1}}{{( {λ}_{owu 6 - 2} )}_{2}} . \qquad ( 25 )$$

The relationship (25) allows determination of a respective relative error of measurements of the thermal conductivity λ in the first part of the selected sample surface and therefore—according the formula (15)—makes it possible to determine and take into account an error of the ratio

$$\frac{{ɛ}_{S} {ρ}_{S}}{{ɛ}_{R} {ρ}_{R}} ,$$

which in turn makes it possible to eliminate a relative error of measurements of the thermal conductivity for all samples of the present series, the latter error being caused by said reasons.

1. A method for determining thermal conductivity and thermal diffusivity of materials, comprising:
registering an electrical signal corresponding to an initial temperature of a surface of at least one sample under study and electrical signals corresponding to initial temperatures of surfaces of at least two reference samples with known thermal conductivity and thermal diffusivity by a first optical temperature sensor which moves relative to the samples under study and to the reference samples at the same speed as an optical heating source,
heating the surfaces of the samples under study and of the reference samples by the optical heating source which moves at the constant speed;
registering electrical signals corresponding to temperatures of the heated surfaces of the samples under study and of the reference samples by a second optical temperature sensor which moves along a heating line relative to the samples under study and to the reference samples at the same speed as the optical heating source;
registering electrical signals corresponding to temperatures of the heated surfaces of the samples under study and of the reference samples, said registering being carried out in parallel to the heating line at a distance therefrom by a third optical temperature sensor which moves relative to the samples under study and to the reference samples at the same speed as the optical heating source and
determining a thermal conductivity of each j^{th} sample under study according to the formula:
$${λ}_{j} = \frac{{\sum }_{i = 1}^{i = N} {λ}_{Ri} \cdot Δ {U}_{1 Ri} \cdot \frac{{ɛ}_{Sj} {ρ}_{Sj}}{{ɛ}_{Ri} {ρ}_{Ri}}}{N \cdot Δ {U}_{1}} ,$$
where λⱼ is the thermal conductivity of the j^{th} sample under study, 1≦j≦N₀;
N₀ is a number of the samples under study;
N is a number of the reference samples;
λRᵢ is a thermal conductivity of i^{th} reference sample, 1≦i≦N;
ΔU_{1Ri} is a difference between output electrical signals of the first and the second temperature sensors registering an initial temperature of the i^{th} reference sample and a temperature of the i^{th} reference sample on the heating line after the heating;
ΔU₁ⱼ is a difference between output electrical signals of the first and the second temperature sensors registering an initial temperature of the j^{th} sample under study and a temperature of the j^{th} sample under study on the heating line after the heating;
ε_{Sj} is a radiation coefficient of the j^{th} sample under study;
ρ_{Sj} is an absorption coefficient of the j^{th} sample under study;
ε_{Ri} is a radiation coefficient of the i^{th} reference sample;
ρ_{Ri} is an absorption coefficient the i^{th} reference sample;
while a thermal diffusivity aⱼ of each j^{th} sample under study is determined according to the formula:
$${a}_{j} = \frac{1}{n} \cdot {\sum }_{m , k = 1}^{m , k = N} \frac{{a}_{Rm} \cdot ln ( \frac{{λ}_{Rm} \cdot Δ {U}_{2 Rm}}{{λ}_{Rk} \cdot Δ {U}_{2 Rk}} \cdot \frac{{ɛ}_{Rk} {ρ}_{Rk}}{{ɛ}_{Rm} {ρ}_{Rm}} )}{\begin{matrix}ln ( \frac{{λ}_{Rm} \cdot Δ {U}_{2 Rm}}{{λ}_{Rk} \cdot Δ {U}_{2 Rk}} \cdot \frac{ɛρ}{{ɛ}_{Rm} {ρ}_{Rm}} ) + \frac{{a}_{Rk} - {a}_{Rm}}{{a}_{Rk}} \cdot \\ ln ( \frac{( {λ}_{Rm} \cdot Δ {U}_{1 Rm} + {λ}_{Rk} \cdot Δ {U}_{1 Rk} ) \cdot Δ {U}_{2 j}}{{λ}_{Rm} \cdot Δ {U}_{1 j} \cdot Δ {U}_{2 Rm} \cdot ( 1 + \frac{{ɛ}_{Rm} {ρ}_{Rm}}{{ɛ}_{Rk} {ρ}_{Rk}} )} )\end{matrix}} ,$$
where
N is a total number of the reference samples;
a_{Rm} and a_{Rk} are thermal diffusivities of m^{th} reference sample and k^{th} reference sample, respectively (1≦m≦N, 1≦k≦N), in and k are elements of combinations of N elements by 2, n is a total number of the combinations of N elements by 2;
ΔU_{2Rm} and ΔU_{2Rk} are differences between output electrical signals of the first and the third temperature sensors registering an initial temperature of the m^{th} and the k^{th} reference samples, respectively, and temperatures of the m^{th} and the k^{th} reference samples, respectively, at a distance from the heating line after the heating;
ΔU₂ⱼ is a difference between output electrical signals of the first and the third temperature sensors registering an initial temperature of the j^{th} sample under study and a temperature of the j^{th} sample under study on the heating line after the heating.

2. A method of claim 1, wherein a ratio of products of the absorption coefficient by the radiation coefficient for the reference samples with the known thermal conductivity and thermal diffusivity is determined as:
$$\frac{{ɛ}_{Rk} {ρ}_{Rk}}{{ɛ}_{Rm} {ρ}_{Rm}} = \frac{Δ {U}_{1 Rk} \cdot {λ}_{Rk}}{Δ {U}_{1 Rm} \cdot {λ}_{Rm}}$$

3. A method of claim 2, wherein the surfaces of the reference samples with the known thermal conductivity and thermal diffusivity are preliminary treated so as to provide the equality:
ε_{Ri}ρ_{Ri}=ε_{R}ρ_{R},
wherein the thermal conductivity of each sample under study is determined as:
$${λ}_{j} = \frac{{\sum }_{i = 1}^{N} {λ}_{Ri} \cdot Δ {U}_{1 Ri}}{N \cdot Δ {U}_{1 j}} \cdot \frac{{ɛ}_{Sj} {ρ}_{Sj}}{{ɛ}_{R} {ρ}_{R}} ,$$
And the thermal diffusivity of each sample under study is determined from the relationship:
$${a}_{j} = \frac{1}{n} {\sum }_{m , k = 1}^{m , k = N} \frac{{a}_{Rm} \cdot ln ( \frac{{λ}_{Rm} \cdot Δ {U}_{2 Rm}}{{λ}_{Rk} \cdot Δ {U}_{2 Rk}} )}{ln ( \frac{{λ}_{Rm} \cdot Δ {U}_{2 Rm}}{{λ}_{Rk} \cdot Δ {U}_{2 Rk}} ) + \frac{{a}_{Rk} - {a}_{Rm}}{{a}_{Rk}} \cdot ln ( \frac{{λ}_{j} \cdot Δ {U}_{21}}{{λ}_{Rm} \cdot Δ {U}_{2 Rk}} )}$$

4. A method of claim 3, wherein the preliminary treatment of the surfaces of the reference samples with the known thermal conductivity and thermal diffusivity consists in applying a thin layer of a homogeneous substance.

5. A method of claim 3, comprising wherein the preliminary treatment of the surfaces of the reference samples with the known thermal conductivity and thermal diffusivity consists in coating with a thin adhesive film.

6. A method of claim 2, wherein if two or more samples under study are used:
the samples under study are divided into groups each including samples under study with identical optical characteristics,
one sample from each group is selected,
thermal conductivity is determined for each selected sample under study,
then a whole surface of each selected sample under study or a part of said surface is treated along the heating line so as to provide the same product of the absorption coefficient by the radiation coefficient of the treated surfaces of the selected samples under study and the reference samples,
thermal conductivity in the treated portions of the selected material samples under study is determined,
based on results of two measurements of the thermal conductivity for the treated surface portions of the selected samples under study, a ratio (εₛρₛ)/(ε_{R}ρ_{R}) of the product of the absorption coefficient by the radiation coefficient of each selected sample under study to the product of the absorption coefficient by the radiation coefficient of the reference samples with the known thermal conductivity and thermal diffusivity is determined for each selected sample under study.

7. A method of claim 6, further comprising:
determining thermal conductivity in untreated portions of the surfaces for each selected sample under study after the treatment of a first part of the surface of the selected sample along the heating line;
comparing differences of signals from the first and the second temperature sensors registering temperature in the untreated portions of each selected sample under study, said differences being obtained before and after the treatment of the surfaces;
determining a variation of a heating power for each sample in measurement after the treatment of the surface with respect to the measurement before the treatment of the surface, and
taking the resulted heating power variation into account in determining a ratio of the product of the absorption coefficient by the radiation coefficient of the selected samples under study to the product of the absorption coefficient by the radiation coefficient of the reference samples with the known thermal conductivity and thermal diffusivity.
